(19) United States
(12) Patent Application Publication
(10) Pub. No.: US 2014/0083271 A1
(43) Pub. Date: Mar. 27, 2014

(54) SYNCHRONOUS CUTTING MECHANISM FOR PIPE MILL

(71) Applicant: AURORA METAL CORP., Taichung City (TW)

(72) Inventor: Chun-Chen Lai, Taichung City (TW)

(73) Assignee: AURORA METAL CORP., Taichung City (TW)

(21) Appl. No.: 13/627,037

(22) Filed: Sep. 26, 2012

(51) Int. Cl. B26D 1/60

(52) U.S. Cl. CPC B26D 1/60
USPC 83/310

(57) ABSTRACT

A synchronous cutting mechanism for a pipe mill includes a carrying table having a sliding pedestal; a speed-adjustable driving set having a speed-adjustable power source, an axle coupled to a driving wheel of the speed-adjustable power source, and a link having one end pivotally connected to the driving wheel at an eccentric point on the driving wheel and an opposite end pivotally connected to the sliding pedestal; a pipe-clamping set for holding a to-be-cut pipe coming from the pipe mill; and a pipe-cutting set for cutting the to-be-cut pipe. When the driving wheel rotates, the link is driven to swing, thereby driving the carrying table and the pipe running out to move in the same direction and with the same velocity, so that the to-be-cut pipe can be cut according to a predetermined length.

### BACKGROUND OF THE INVENTION

1. Technical Field

The present invention relates to a synchronous cutting mechanism for a pipe mill. More Particularly, the cutting mechanism serves to linearly convey a pipe formed by a pipe mill and synchronously cut the pipe into segments of a predetermined length.

2. Description of Related Art

Pipe mills are well known for effectively making various metal pipes, such as stainless steel pipes and iron pipes. As shown in FIG. 1, for manufacturing pipe products, a lengthwise metal plate is fed into a pipe mill to be rolled into a semi-finished pipe with a predetermined sectional shape, such as circularity, ellipse or square. Then the semi-finished pipe receives solder bonding, stretching and grinding or more finishing treatment, before conveyed to a cutting mechanism where it will be cut into segments of desired lengths.

A conventional cutting mechanism for such a pipe mill is shown in FIG. 2. It primarily comprises a carrying table 1, a base 2 allowing the carrying table 1 to slide thereon, a hydraulic cylinder 3 for moving the carrying table 1, and a cutting device 4 deposited on the carrying table 1. The carrying table 1 serves to receive a to-be-cut pipe 5 made by and running out from the pipe mill. Since the pipe mill produce the pipe in a continuous fashion, the to-be-cut pipe 5 runs out continuously with a velocity V1. When the to-be-cut pipe 5 passes the cutting device 4 for a predetermined length for cutting, the hydraulic cylinder 3 drives the carrying table 1 to slide, so as to make the carrying table 1 move abreast with the to-be-cut pipe 5 with a velocity V2. At this time, in order to maintain the cutting device 4 at the set cut point that defines the cut segment with the determined length, the velocities V1 and V2 must be equal. After the cutting operation, the hydraulic cylinder 3 returns the carrying table 1 back to its initial position, thereby preparing the cutting mechanism for the next round of cutting operation.

In the foregoing operation, it is critical to keep the movement velocity V2 of the carrying table and the output velocity V1 of the to-be-cut pipe equal. Otherwise, in a case where V2 is greater than V1, the length of the cut segment will be smaller than the predetermined length. On the contrary, of the movement velocity V2 of the carrying table is smaller than the output velocity V1 of the to-be-cut pipe, the cut segment will be longer than the predetermined length, and in an even worse case, the cutting blade may hinder the smooth progress of the pipe, which can cause mechanical damage.

In this regard, however, the conventional cutting mechanism using a hydraulic cylinder has innate defects. When operating, a hydraulic cylinder uses therein highly pressured liquid to drive a piston to thrust, thereby making the shaft of the hydraulic cylinder to travel. In other words, the travel velocity of the hydraulic cylinder shaft is dependent on the pressure of the input liquid. However, even if the pressure level of the liquid is controlled, there are many factors having influence on the travel velocity of the cylinder shaft, such as the volume of the cylinder, the ambient temperature and so on. These all make accurate cutting very challenging. Furthermore, the driving velocity of the hydraulic cylinder is limited, and may be inadaptable to high-speed pipe manufacturing. Besides, the hydraulic cylinder is made to have a fixed velocity that is difficult to adjust at will.

### SUMMARY OF THE INVENTION

As described above, the existing cutting mechanisms for pipe mills usually use a hydraulic cylinder for driving, so it is difficult to concert the movement velocity of the cutting device and the output velocity of the to-be-cut pipe, leading to inaccuracy in length of the final pipe products. To address the problems of the prior art, the present invention provides a synchronous cutting mechanism, which, when working with a pipe mill, ensures its cutting operation to be synchronous with the output velocity of the to-be-cut pipe and is adaptable when output of the pipe mill changes.

According to the present invention, a synchronous cutting mechanism for a pipe mill comprises:

a carrying table having a sliding pedestal mounted and sliding on a base;

a speed-adjustable driving set that has a speed-adjustable power source, an axle coupled to a driving wheel of the speed-adjustable power source, and a link, in which the link has one end pivotally connected to the driving wheel at an eccentric point on the driving wheel and an opposite end pivotally connected to the sliding pedestal;

a pipe-clamping set deposited on the carrying table for holding a to-be-cut pipe coming from the pipe mill; and

a pipe-cutting set deposited on the carrying table for cutting the to-be-cut pipe.

One objective of the present invention is to provide a synchronous cutting mechanism wherein when the driving wheel rotates, the link is driven to swing and thereby make the carrying table to move with the to-be-cut pipe running out from the pipe mill in the same direction and with the same velocity, so that the to-be-cut pipe can be cut into segments of a predetermined length.

Another objective of the present invention is to provide the synchronous cutting mechanism having the pipe-clamping set that hold the to-be-cut pipe in position on the carrying table, so that the pipe-cutting set can cut the to-be-cut pipe at a right point.

Still another objective of the present invention is to provide the synchronous cutting mechanism having a servo motor as its speed-adjustable power source, so that the rotation velocity of the driving wheel can be adjusted by the user as needed, thereby changing the movement velocity of the carrying table. When the output velocity of the to-be-cut pipe changes as a result of making pipes of different sizes or types, the movement velocity of the carrying table can be easily matched with that of the to-be-cut pipe.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a flowchart illustrating a pipe-making process of a pipe mill;

FIG. 2 is a schematic drawing of a conventional cutting mechanism;

FIG. 3 is a partially exploded view of a cutting mechanism according to the present invention;

FIG. 4 is a perspective view of the cutting mechanism according to the present invention; and

FIG. 5 through FIG. 7 illustrate operation of the cutting mechanism according to the present invention.

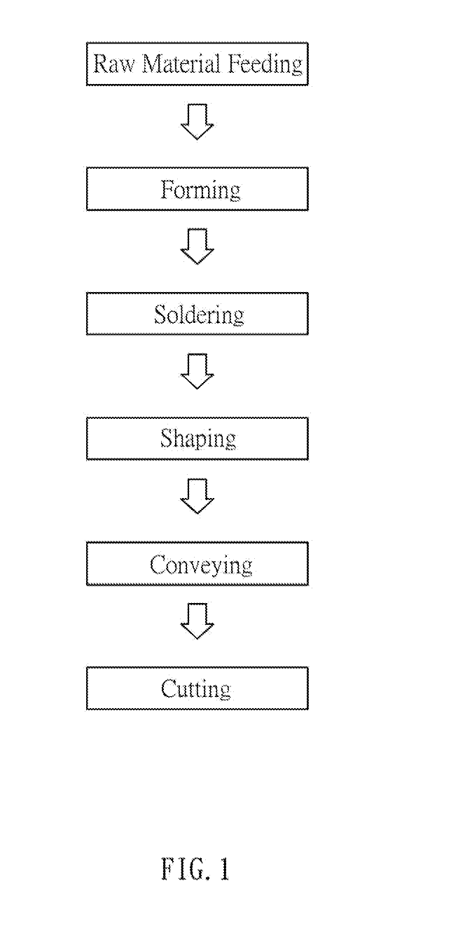

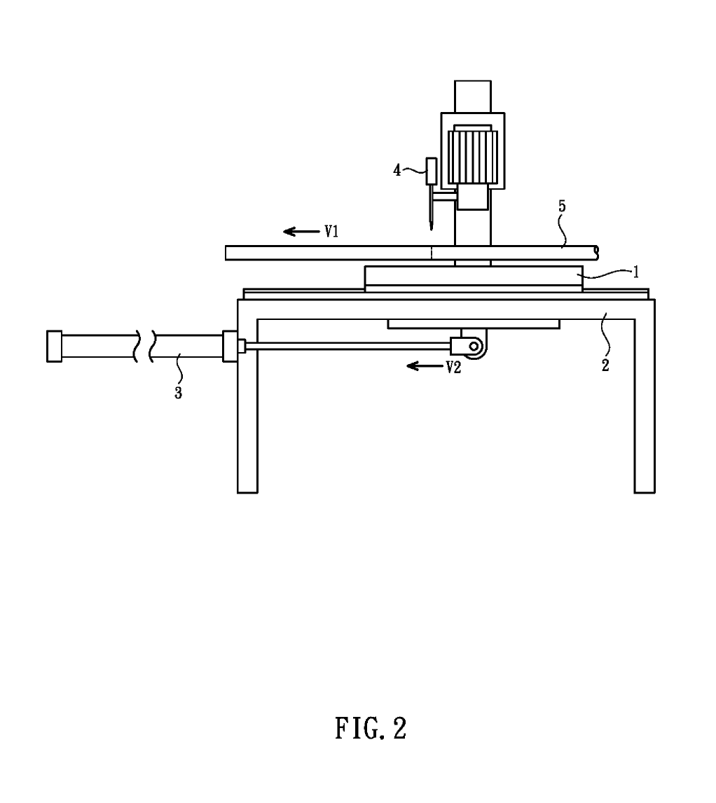

### DETAILED DESCRIPTION OF THE INVENTION

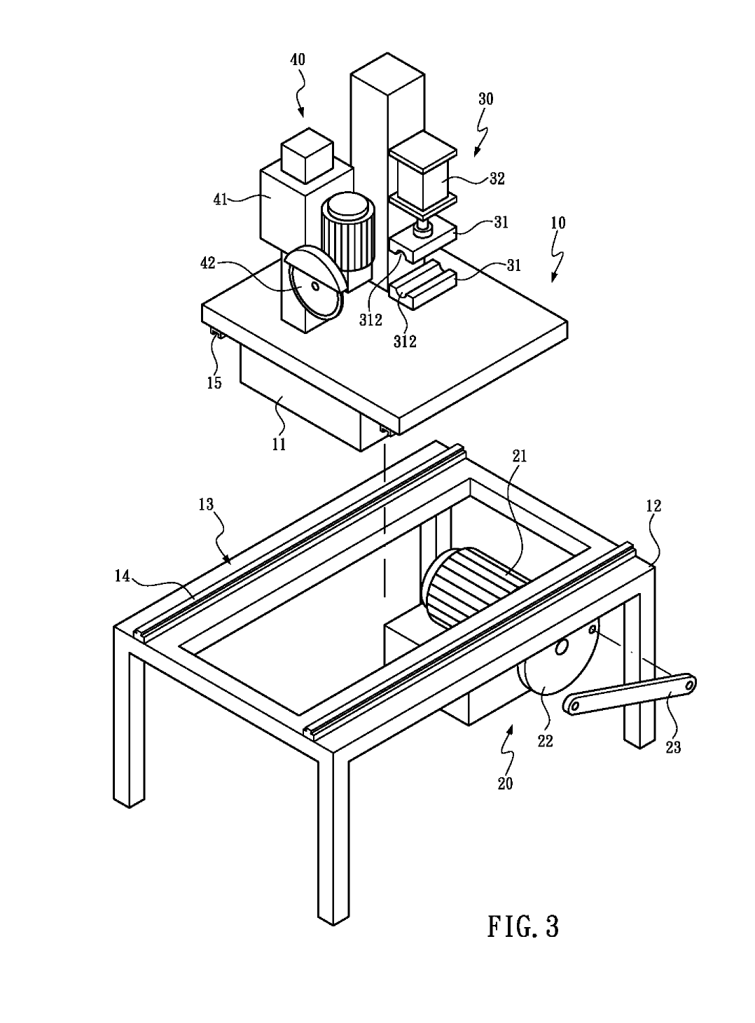

Referring to FIG. 3 to FIG. 5, in one embodiment of the present invention, a synchronous cutting mechanism designed for a pipe mill primarily comprises a carrying table 10, a speed-adjustable driving set 20, a pipe-clamping set 30, and a pipe-cutting set 40.

The carrying table 10 has a sliding pedestal 11 that is mounted on and slides along a base 12. The sliding pedestal 11 is mounted on the base 12 through a slide rail assembly 13 that allows the sliding pedestal 11 to slide along the base 12. The slide rail assembly 13 may be realized by a conventional ball guide or linear guide, or by a combination of a dovetail ridge 14 and a matching dovetail groove 15.

The speed-adjustable driving set 20 has a speed-adjustable power source 21, which may be a servo motor. The speed-adjustable driving set 20 further has an axle coupled to a driving wheel 22 of the speed-adjustable power source 21, and has a link 23. The link 23 has one of its ends pivotally connected to the driving wheel 22 at an eccentric point on the driving wheel 22 and the other end pivotally connected to the sliding pedestal 11.

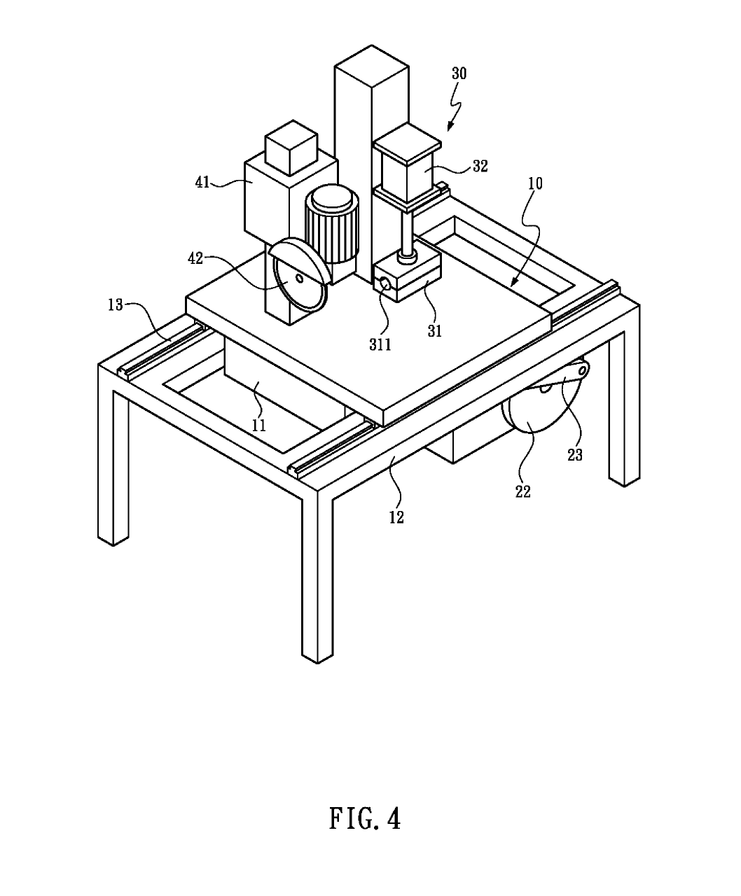

The pipe-clamping set 30 is deposited on the carrying table 10 for holding a to-be-cut pipe 90 running out from a pipe mill (not shown). The pipe-clamping set 30 comprises two clamping chunks 31 and a driving device 32. A receiving slot 311 (shown clearly in FIG. 4) is formed between the two clamping chunks 31 when they closely contact each other. In the present embodiment, each of the two clamping chunks 31 is formed with a receiving recess 312 so that when the two clamping chunks 31 combine, the two receiving recesses 312 jointly form the receiving slot 311. The driving device 32 is configured to drive the two clamping chunks 31 to move relatively, so as to hold or release the to-be-cut pipe 90.

The pipe-cutting set 40 is deposited on the carrying table 10 for cutting the to-be-cut pipe 90. Therein, the pipe-cutting set 40 comprises a lifting set 41 and at least one cutting blade 42.

Preferably, the pipe-clamping set 30 and the pipe-cutting set 40 are arranged along the output path of the to-be-cut pipe 90 successively.

After illustrating the configuration of the certain embodiment of the present invention, the description will be directed to the operational principles of the present invention.

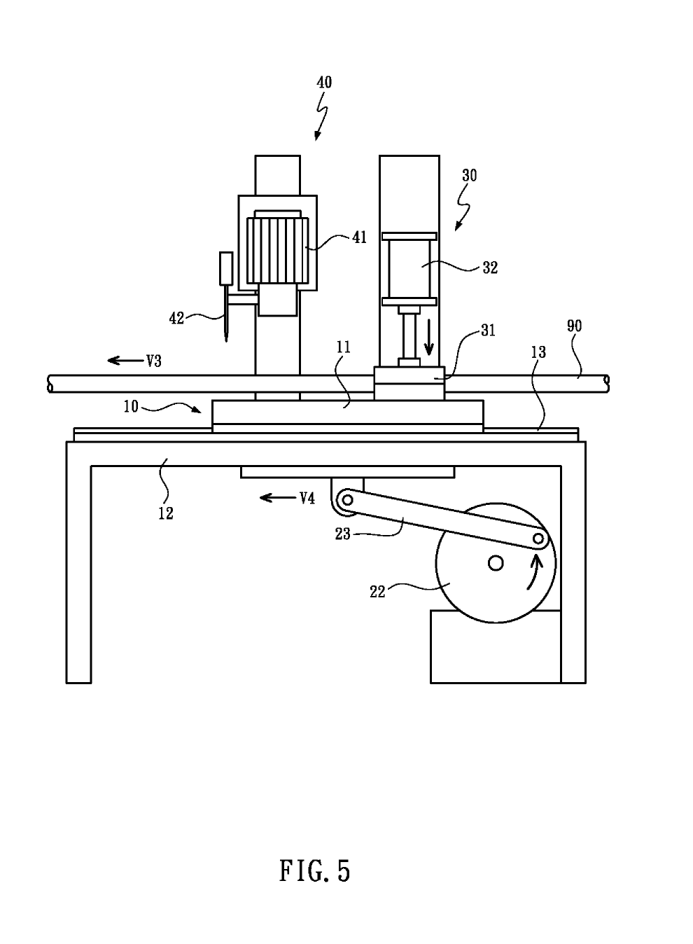

As shown in FIG. 5, the present invention functions as the speed-adjustable power source 21 drives the driving wheel 22 to in turn swing the link 23. As a result, the carrying table 10 is moved by the swinging link 23 and slides along the base 12. The slide velocity V4 of the carrying table 10 can therefore be adjusted by changing the rotation velocity of the speed-adjustable power source 21. For example, when the to-be-cut pipe 90 is running out from the pipe mill in a velocity V3, for well cutting the to-be-cut pipe 90, the speed-adjustable power source 21 makes the carrying table 10 to move abreast with the to-be-cut pipe 90 running out of the pipe mill. That is, the carrying table 10 and the to-be-cut pipe 90 are moving in the same direction and with the same velocity (V3=V4). At the same time, the pipe-clamping set 30 is driven by the driving device 32 to hold the to-be-cut pipe 90 between the clamping chunks 31, i.e. in the receiving slot 311, so as to ensure the to-be-cut pipe 90 and the carrying table 10 move abreast smoothly.

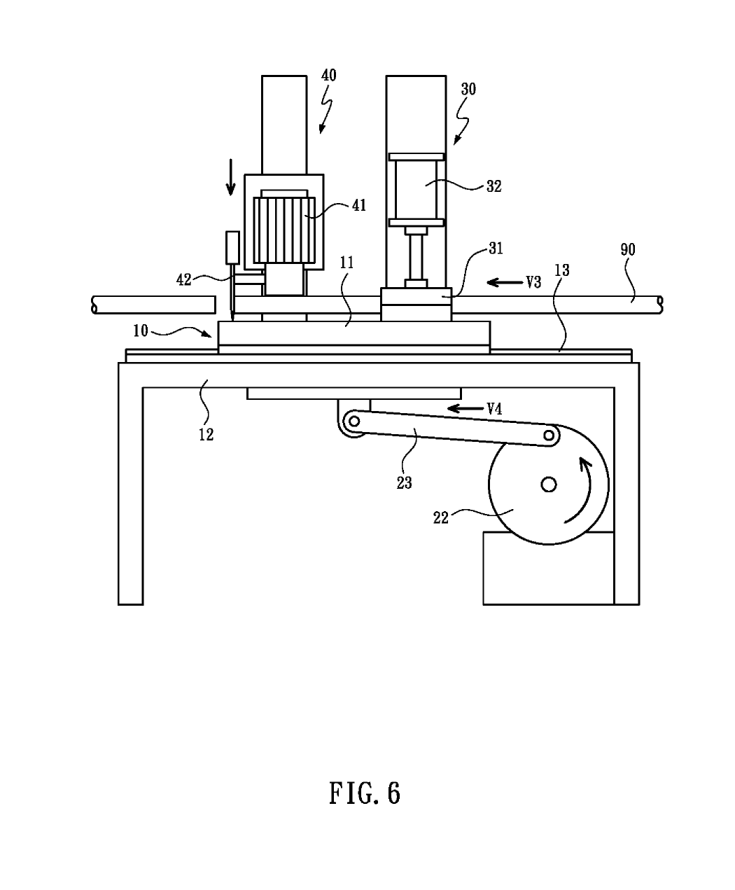

As shown in FIG. 6, when the pipe-clamping set 30 holds the to-be-cut pipe 90 in position on the carrying table 10, the cutting blade 42 of the pipe-cutting set 40 is well positioned and aligned with a cut point with respect to the to-be-cut pipe 90. The lifting set 41 then can drive the cutting blade 42 to move up and down as the to-be-cut pipe 90 running out with a velocity V3, so as to cut the to-be-cut pipe 90 at the cut point.

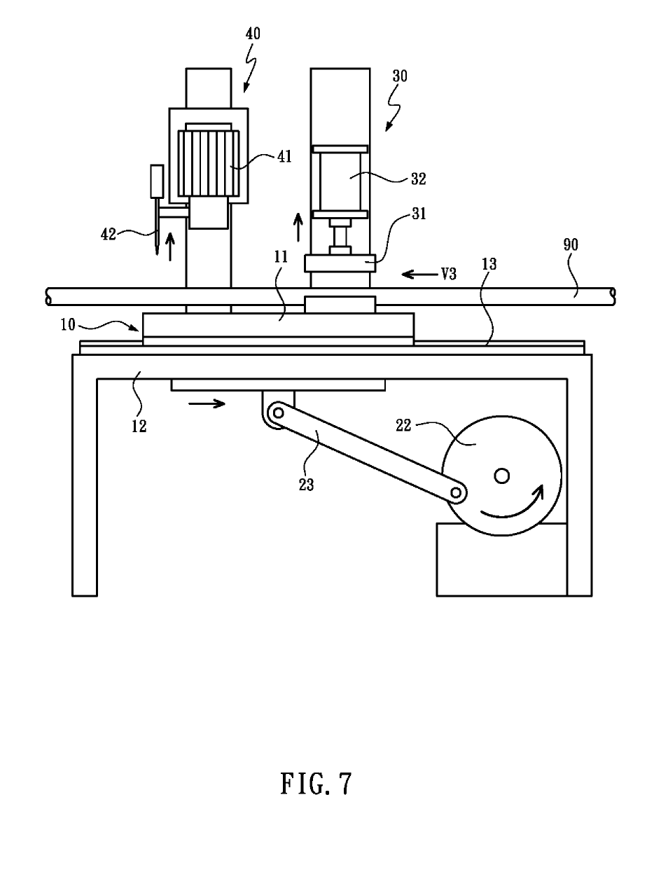

As shown in FIG. 7, when the to-be-cut pipe 90 is cut into segments with a predetermined length, the pipe-clamping set 30 opens the two clamping chunks 31 to thereby release the to-be-cut pipe 90. Then, as the driving wheel 22 rotates, the link 23 moves reversely to return the carrying table 10 to its initial position, thereby preparing the disclosed mechanism for the next round of cutting operation.

Additionally, in the embodiment where the speed-adjustable power source 21 is a servo motor, the rotation velocity of the driving wheel 22 can be adjusted by the user as needed, thereby changing the movement velocity of the carrying table 10. This is advantageous for not only controlling the movement velocity of the carrying table 10, but also for the possibility that when the output velocity of the to-be-cut pipe 90 changes as a result of making pipes of different sizes or types, the movement velocity of the carrying table 10 can be easily matched with that of the to-be-cut pipe 90.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A synchronous cutting mechanism for a pipe mill, the synchronous cutting mechanism comprising:
a carrying table having a sliding pedestal mounted on and sliding along a base;
a speed-adjustable driving set that has a speed-adjustable power source, an axle coupled to a driving wheel of the speed-adjustable power source, and a link, in which the link has one end pivotally connected to the driving wheel at an eccentric point on the driving wheel and an opposite end pivotally connected to the sliding pedestal;
a pipe-clamping set deposited on the carrying table for holding a to-be-cut pipe coming from the pipe mill; and
a pipe-cutting set deposited on the carrying table for cutting the to-be-cut pipe,
whereby when the driving wheel rotates, the link is driven to swing, so as to drive the carrying table and the to-be-cut pipe coming out from the pipe mill to move in the same direction and with the same velocity, so that the pipe-cutting set cuts the to-be-cut pipe according to a predetermined length.

2. The synchronous cutting mechanism of claim 1, wherein the sliding pedestal is mounted on the base through a slide rail assembly, so that the sliding pedestal is able to slide along the base.

3. The synchronous cutting mechanism of claim 1, wherein the sliding pedestal is mounted on the base through a dovetail ridge and a dovetail groove matching with the dovetail ridge, so that the sliding pedestal is able to slide along the base.

4. The synchronous cutting mechanism of claim 1, wherein the pipe-clamping set comprises two clamping chunks and a driving device, in which the driving device is configured to drive the two clamping chunks to move relatively, so as to hold or release the to-be-cut pipe.

5. The synchronous cutting mechanism of claim 4, wherein a receiving slot is formed between the two clamping chunks when the two clamping chunks closely contact each other.

6. The synchronous cutting mechanism of claim 1, wherein the pipe-cutting set comprises a lifting set and at least one cutting blade.

7. The synchronous cutting mechanism of claim 1, wherein the speed-adjustable power source is a servo motor.
